(19) United States
(12) Patent Application Publication
(10) Pub. No.: US 2016/0144383 A1
(43) Pub. Date: May 26, 2016

(54) INJECTION DEVICE AND METHOD FOR INJECTING LIQUID

(71) Applicants: Fu Tai Hua Industry (Shenzhen) Co., Ltd., Shenzhen (CN); HON HAI PRECISION INDUSTRY CO., LTD., New Taipei (TW)

(72) Inventors: WEN-JIAN PANG, Shenzhen (CN); SUO-BING SU, New Taipei (TW)

(21) Appl. No.: 14/575,796

(22) Filed: Dec. 18, 2014

(30) Foreign Application Priority Data
Nov. 21, 2014 (CN) 201410674876.4

(51) Int. Cl. B05B 1/30; G05B 15/02

(52) U.S. Cl. CPC B05B 1/30; G05B 15/02

(57) ABSTRACT

A method of injecting liquid using an injection device, the injection device includes an infrared transceiver, which transmits infrared lights, and receives reflected infrared lights that are reflected by an object. A nozzle, and a control unit further are included in the injection device. The control unit is in communication with the infrared transceiver and the nozzle through a data bus. Once the control unit detects a size of the object according to a number of the reflected infrared lights that are received by the infrared transceiver, the control unit controls the nozzle injecting liquid with a predetermined volume according to the size of the object.

### CROSS-REFERENCE TO RELATED APPLICATIONS

This application claims priority to Chinese Patent Application No. 201410674876.4 filed on Nov. 21, 2014, the contents of which are incorporated by reference herein.

### FIELD

The subject matter herein generally relates to controlling technology, and particularly to an injection device and a method for injecting liquid using the injection device.

### BACKGROUND

A user may carelessly forget to turn off a water faucet after wash hands. A leaking water faucet can waste a lot of water.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an injection device.

FIG. 2 illustrates a flowchart of one embodiment of a method for injecting liquid.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

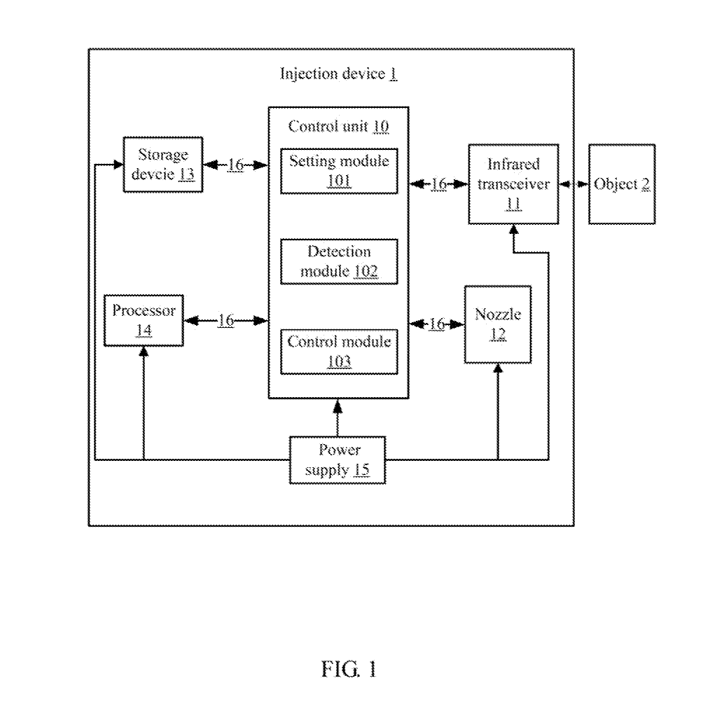

FIG. 1 is a block diagram of one embodiment of an injection device. Depending on the embodiment, an injection device 1 includes a control unit 10, an infrared transceiver 11, a nozzle 12, a storage device 13, at least one processor 14, and a power supply 15. The control unit 10 is in communication with the infrared transceiver 11, the nozzle 12, the storage device 13, and the at least one processor 14 through a data bus 16. The infrared transceiver 11 transmits infrared lights, and receives reflected infrared lights that are reflected by an object 2. The nozzle 12 is used to inject liquid such as water or hand sanitizer. The power supply 15 supplies power for the injection device 1.

The injection device 1 may be a water faucet or a hand sanitizer device, and the object 2 can be a user's hand. FIG. 1 illustrates only one example of the injection device 1 that may include more or fewer components than illustrated, or have a different configuration of the various components in other embodiments.

In at least one embodiment, the control unit 10 determines a size of the object 2, according to a number of reflected infrared lights that are received by the infrared transceiver 11. The control unit 10 controls the nozzle 12 injecting liquid with a predetermined volume according to the size of the object 2.

It should be noted that when the infrared transceiver 11 transmits infrared lights to the object 2, the greater the size of the object 2 is, the more reflected infrared lights are received by the infrared transceiver 11.

The storage device 13 can be an internal storage device, such as a flash memory, a random access memory (RAM) for temporary storage of information, and/or a read-only memory (ROM) for permanent storage of information. The storage device 13 can also be an external storage device, such as an external hard disk, a storage card, or a data storage medium. The at least one processor 14 can be a central processing unit (CPU), a microprocessor, or other data processor chip that performs functions of the injection device 1.

In at least one embodiment, the control unit 10 may include a setting module 101, a detection module 102 and a control module 103. The function modules 101, 102, and 103 may include computerized codes in the form of one or more programs, which are stored in the storage device 13, and are executed by the at least one processor 14 to provide functions of the present disclosure. Details will be given in the following paragraphs.

The setting module 101 predetermines a plurality of size ranges for the object 2, corresponding to a plurality of numbers of the reflected lights that are received by the infrared transceiver 11. The setting module 101 further predetermines a plurality of volumes of liquid for the nozzle 12, corresponding to the plurality of size ranges of the object 2.

For example, the setting module 101 predetermines a first size range for the object 2, when the infrared transceiver 11 receives more than 20 reflected infrared lights that are reflected by the object 2. The setting module 101 further predetermines the nozzle 12 to inject liquid with 15 milliliters when the size of object 2 is determined to be within the first size range.

For another example, the setting module 101 predetermines a second size range for the object 2, when the number of the reflected infrared lights that are received by the infrared transceiver 11 is within a range of [10, 20]. The setting module 101 further predetermines the nozzle 12 to inject liquid with 10 milliliters when the size of object 2 is determined to be within the second size range. The setting module 101 predetermines a third size range for the object 2, when the infrared transceiver 11 receives less than 10 reflected infrared lights that are reflected by the object 2. The setting module 101 further predetermines the nozzle 12 to inject liquid with 5 milliliters when the size of object 2 is determined to be within the third size range.

The detection module 102 detects the size of the object 2 according to the number of the reflected infrared lights that are received by the infrared transceiver 11. For example, the detection module 102 determines the size of the object 2 to be within the first size range when the infrared transceiver 11 receives 25 reflected infrared lights that are reflected by the object 2.

The control module 103 controls the nozzle 12 injecting liquid with the predetermined volume according to the size of the object 2. For example, the control module 103 controls the nozzle 12 injecting liquid with 15 milliliters when the size of the object 2 is determined to be within the first size range.

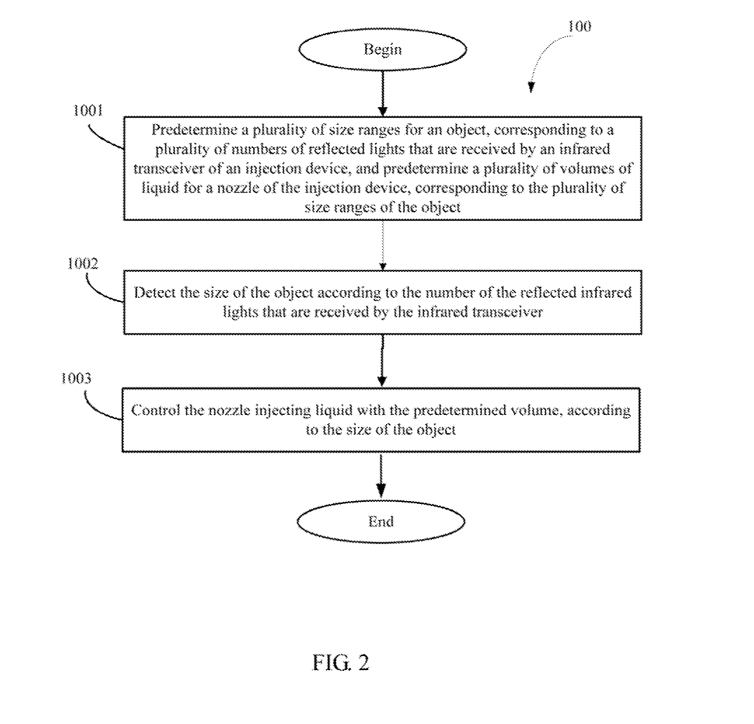

FIG. 2 illustrates a flowchart is presented in accordance with an example embodiment. The example method 100 is provided by way of example, as there are a variety of ways to carry out the method. The method 100 described below can be carried out using the configurations illustrated in FIG. 1, for example, and various elements of these figures are referenced in explaining example method 100. Each block shown in FIG. 2 represents one or more processes, methods or subroutines, carried out in the exemplary method 100. Furthermore, the illustrated order of blocks is by example only and the order of the blocks can be changed according to the present disclosure. The exemplary method 100 can begin at block 1001. Depending on the embodiment, additional steps can be added, others removed, and the ordering of the steps can be changed.

At block 1001, an setting module predetermines a plurality of size ranges for an object, corresponding to a plurality of numbers of reflected lights that are received by an infrared transceiver of an injection device. The setting module further predetermines a plurality of volumes of liquid for a nozzle of the injection device, corresponding to the plurality of size ranges of the object.

For example, the setting module predetermines a first size range for the object, when the infrared transceiver receives more than 20 reflected infrared lights that are reflected by the object. The setting module further predetermines the nozzle to inject liquid with 15 milliliters when the size of object is determined to be with the first size range.

For another example, the setting module predetermines a second size range for the object, when the number of the reflected infrared lights that are received by the infrared transceiver is within a range of [10, 20]. The setting module further predetermines the nozzle to inject liquid with 10 milliliters when the size of object is determined to be within the second size range. The setting module predetermines a third size range for the object, when the infrared transceiver receives less than 10 reflected infrared lights that are reflected by the object. The setting module further predetermines the nozzle to inject liquid with 5 milliliters when the size of object is determined to be within the third size range.

At block 1002, a detection module detects the size of the object according to the number of the reflected infrared lights that are received by the infrared transceiver. For example, the detection module determines the size of the object to be within the first size range, when the infrared transceiver receives 25 reflected infrared lights that are reflected by the object.

At block 1003, a control module controls the nozzle injecting liquid with the predetermined volume, according to the size of the object. For example, the control module controls the nozzle injecting liquid with 15 milliliters when the size of the object is determined to be within the first size range.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An injection device comprising:
an infrared transceiver, configured to transmit and receive infrared light;
a nozzle;
a control unit in communication with the infrared transceiver and the nozzle through a data bus;
at least one processor; and
a storage device storing a plurality of instructions, which when executed by the processor, cause the processor to:
detect, via the control unit, a size of an object according to a number of the reflected infrared lights that are received by the infrared transceiver; and
control, via the control unit, the nozzle injecting liquid with a predetermined volume according to the size of the object.

2. A computer-implemented method for injecting liquid using an injection device, the injection device comprising an infrared transceiver, configured to transmit and receive infrared light, a nozzle; a control unit in communication with the infrared transceiver and the nozzle through a data bus; the injection device further comprising at least one processor, the method comprising:
detecting, via the control unit, a size of an object according to a number of the reflected infrared lights that are received by the infrared transceiver; and
controlling, via the control unit, the nozzle injecting liquid with a predetermined volume according to the size of the object.

3. A non-transitory storage medium having stored thereon instructions that, when executed by a processor of an injection device, causes the processor to perform a method for injecting liquid using the injection device, the injection device comprising an infrared transceiver, configured to transmit and receive reflected infrared lights, the injection device further comprising a nozzle, a control unit that is in communication with the infrared transceiver and the nozzle through a data bus, wherein the method comprises:
detecting, via the control unit, a size of an object according to a number of the reflected infrared lights that are received by the infrared transceiver; and
controlling, via the control unit, the nozzle injecting liquid with a predetermined volume according to the size of the object.
